(19) United States
(12) Patent Application Publication
(10) Pub. No.: US 2021/0042298 A1
(43) Pub. Date: Feb. 11, 2021

(54) PROGRAM STORAGE MEDIUM, DEVICE, AND METHOD FOR SHORTEST PATH SEARCH

(71) Applicant: FUJITSU LIMITED, Kawasaki-shi (JP)

(72) Inventor: Yasuo Yamane, Machida (JP)

(73) Assignee: FUJITSU LIMITED, Kawasaki-shi (JP)

(21) Appl. No.: 16/984,300

(22) Filed: Aug. 4, 2020

(30) Foreign Application Priority Data
Aug. 9, 2019 (JP) 2019-147202

(51) Int. Cl. G06F 16/245; G06F 16/901

(52) U.S. Cl. CPC G06F 16/245; G06F 16/9024

(57) ABSTRACT

A shortest path search method includes a process of K1-shortest path search (K1: a positive integer) from a first vertex to a second vertex in graph structure data that includes a plurality of vertices and a plurality of edges. The method includes: based on a shortest path from the first vertex to respective vertices and a shortest path from the second vertex to respective vertices, deriving each of shortest passing paths which are shortest paths of paths from the first vertex to the second vertex using any of the respective vertices as a passing point, generating contracted graph structure data in which vertices and edges that are not included in any of the shortest passing paths of top K2 (K2>=K1) having a short distance are removed from the graph structure data, and performing the process of K1-shortest path search with respect to the contracted graph structure data.

### CROSS-REFERENCE TO RELATED APPLICATION

This application is based upon and claims the benefit of priority of the prior Japanese Patent Application No. 2019-147202, filed on Aug. 9, 2019, the entire contents of which are incorporated herein by reference.

### FIELD

The embodiments discussed herein are related to a shortest path search program storage medium, a shortest path search device, and a shortest path search method.

### BACKGROUND

In a network graph including a plurality of vertices and a plurality of edges representing a coupling relationship between the vertices, there is a technology called k-shortest path search for searching k paths (hereinafter referred to as “k-shortest path”) from the shortest path to the k-th path among a plurality of paths from a vertex as a start point to a vertex as an end point.

The k-shortest path search is important for obtaining a quasi-shortest path other than the shortest path, and recently becomes more important as a method for analyzing a graph. Finding the shortest path between two vertices in a graph is important to know the basic relationship between the elements indicated by the two vertices, this is because a more detailed relationship may be known by finding the k-shortest path between the two vertices. For example, as an application example of the k-shortest path search, the following may be considered.

For example, by performing the k-shortest path search with respect to a graph representing a transportation network such as a railroad network, a road network, or a flight network, a quasi-shortest path may be searched in addition to the shortest path between points. It is important for both the general public and the forwarding agents to grasp the quasi shortest path. For example, the quasi shortest path may be used as a bypass path when a trouble occurs on the shortest path. Even when the shortest path is optimal in terms of distance or time, a quasi-shortest path may be advantageous in terms of cost or other aspects.

For example, in a social networking service (SNS), with a person as a vertex, then a graph of human relationships may be created by coupling people who have a friendship with each other or people who are exchanging e-mails in-house with edges. By obtaining the shortest path between the vertices corresponding to two persons, it is possible to grasp what kind of person is related between the two persons. By obtaining the quasi shortest path, it is possible to grasp a more detailed human relationship.

For example, in a graph having a company as a vertex and a flow of money between companies as edges, by obtaining not only the shortest path but also the quasi shortest path, it is possible to analyze in detail which company is related between two companies as in the example of the human relationship described above.

As a method of the k-shortest path search as described above, there is a method of obtaining a shortest path different from the shortest path already obtained by obtaining the shortest path in a graph from which edges included in the shortest path already obtained are removed.

There is also a method in which the Dijkstra method, which is an algorithm for the shortest path search, is extended to the k-shortest path.

An example of the related art includes Yen, J. Y. (1971). “Finding the K Shortest Loopless Paths in a Network”. Management Science. 17 (11): 712-716. doi:10.1287/mnsc.17.11.712.

### SUMMARY

According to an aspect of the embodiments, a shortest path search method, performed by a computer, to execute a process of K1-shortest path search (K1 is a positive integer) from a first vertex to a second vertex in graph structure data that includes a plurality of vertices and a plurality of edges representing a coupling relationship between the vertices, the method includes: based on a shortest path from the first vertex to respective vertices included in the plurality of vertices and a shortest path from the second vertex to respective vertices included in the plurality of vertices, deriving each of shortest passing paths which are shortest paths of paths from the first vertex to the second vertex using any of the respective vertices as a passing point, generating contracted graph structure data in which, among the shortest passing paths, vertices and edges that are not included in any of the shortest passing paths of top K2 (K2 is a positive integer greater than or equal to K1) having a short distance are removed from the graph structure data, and performing the process of K1-shortest path search with respect to the contracted graph structure data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an outline of an embodiment;

FIG. 2 is a functional block diagram of a shortest path search device according to first and second embodiments;

FIG. 3 is a diagram for explaining derivation of a shortest passing path;

FIG. 4 is a diagram illustrating an example of a shortest passing path that includes a loop;

FIG. 5 is a diagram illustrating an example of a shortest passing path that does not include a loop;

FIG. 6 is a block diagram illustrating a schematic configuration of a computer that functions as a shortest path search device according to the first and second embodiments;

FIG. 7 is a flowchart illustrating an example of a shortest path search process according to the first embodiment;

FIG. 8 is a diagram illustrating an example of sets of shortest passing paths;

FIG. 9 is a diagram illustrating an example of sets of shortest passing paths from which duplications are excluded;

FIG. 10 is a diagram illustrating an example of sets of shortest passing paths sorted in ascending order of distance;

FIG. 11 is a diagram illustrating an example of all sets of shortest passing paths up to a k-th shortest passing path that does not include a loop, and a set of vertices that is included in a contracted graph;

FIG. 12 is a diagram for explaining generation of the contracted graph;

FIG. 13 is a diagram illustrating an example of a k-shortest path searched from the contracted graph;

FIG. 14 is a flowchart illustrating an example of a shortest path search process according to the second embodiment;

FIG. 15 is a diagram illustrating an example of sets of shortest passing paths sorted in ascending order of distance;

FIG. 16 is a diagram illustrating an example of sets of shortest passing paths when the process is performed for the first time and a set of vertices;

FIG. 17 is a diagram illustrating an example of sets of shortest passing paths when the process is performed for the second time and a set of vertices;

FIG. 18 is a diagram illustrating an example of sets of shortest passing paths when the process is performed for the third time and a set of vertices;

FIG. 19 is a diagram illustrating an example of sets of shortest passing paths when the process is performed for the fourth time and a set of vertices;

FIG. 20 is a diagram for explaining exclusion of a duplicated shortest passing path;

FIG. 21 is a diagram illustrating an example of a shortest passing path including a linear loop;

FIG. 22 is a diagram illustrating an example of a shortest passing path including a circular loop;

FIG. 23 is a graph illustrating a performance comparison between k-Dij and GR (k-Dij);

FIG. 24 is a table illustrating details of a performance comparison between k-Dij and GR (k-Dij); and

FIG. 25 is a table illustrating details of a performance comparison between k-Dij and GR (k-Dij).

### DESCRIPTION OF EMBODIMENTS

In the related art, the processing cost of the k-shortest path search is higher than that of the shortest path search that obtains only the first shortest path. For example, as the number of vertices included in the graph increases, the processing cost of the k-shortest path search also increases.

In one aspect, the disclosed technology aims to reduce the processing cost of the k-shortest path search.

First, before describing the details of each embodiment, an outline of each embodiment will be described.

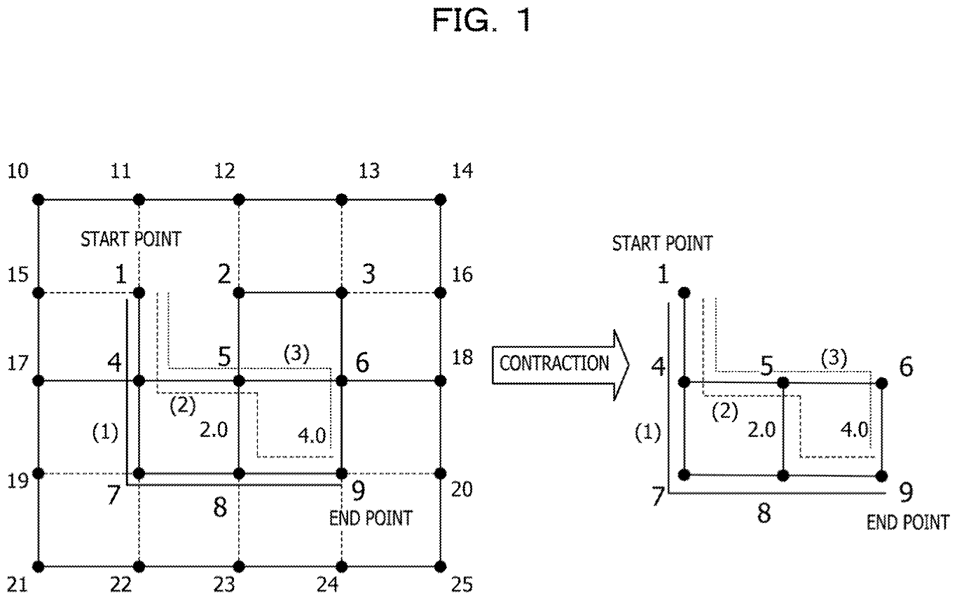

The basic idea of each embodiment is to contract an original graph to a sub-graph that may include a k-shortest path which is the solution, as illustrated in FIG. 1. In the original graph illustrated in the left diagram in FIG. 1, black circles are vertices, lines that couple between each of the vertices are edges, and numerical values of integer written together with the vertices are identification numbers of the vertices (hereinafter referred to as “vertex numbers”). Hereinafter, the vertex having the vertex number i is expressed as “vertex i”. The original graph illustrated in the left diagram in FIG. 1 includes 25 vertices from vertex 1 to vertex 25. The numerical values up to the first decimal place written together with the edge are the weights of the edge, and the edge of the solid line where the weight is not written together is the weight 1.0, and the edge of the broken line is the weight 10.0.

In the graph illustrated in FIG. 1, as k=3, when the 3-shortest path from a vertex 1 that is a start point (hereinafter, also referred to as “start point 1”) to a vertex 9 that is an end point (hereinafter, also referred to as “end point 9”) is obtained, three paths, the solid line (1), the broken line (2), and the dotted line (3) are obtained in ascending order of distance. In the embodiment, the original graph including 25 vertices is contracted to a sub-graph that includes these 3 paths and is constituted by 7 vertices (or a sub-graph that includes 7 vertices and is constituted by fewer vertices than the original graph G). When the graph is able to be contracted to a small-sized graph (a graph having a small number of vertices) at high speed, a k-shortest path may be obtained at high speed by applying any existing k-shortest path search methods to the contracted graph.

The method of the present embodiment is a meta method in the sense that any existing k-shortest path search methods may be applied. In the present embodiment, a method of contracting a graph is referred to as a graph reduction (GR) method, and a method of searching for a k-shortest path from a contracted graph using any existing k-shortest path search method E is referred to as a GR (E) method.

Hereinafter, an example of an embodiment according to the disclosed technology will be described with reference to the drawings.

In the k-shortest path search, there is a method that allows a path including a loop and a method that does not allow a path including a loop in the shortest path. In each of the following embodiments, a method of not allowing a path including a loop desiring a higher processing cost will be described. The graphs include an undirected graph and a directed graph, and a weighted graph and an unweighted graph, and 4 types (=2×2) of graphs may be considered as combinations thereof. Although the disclosed technology is applicable to all types thereof, in the following, in order to simplify the description, the case of a coupled weighted graph will be described, and other types of graphs will be supplemented later.

### First Embodiment

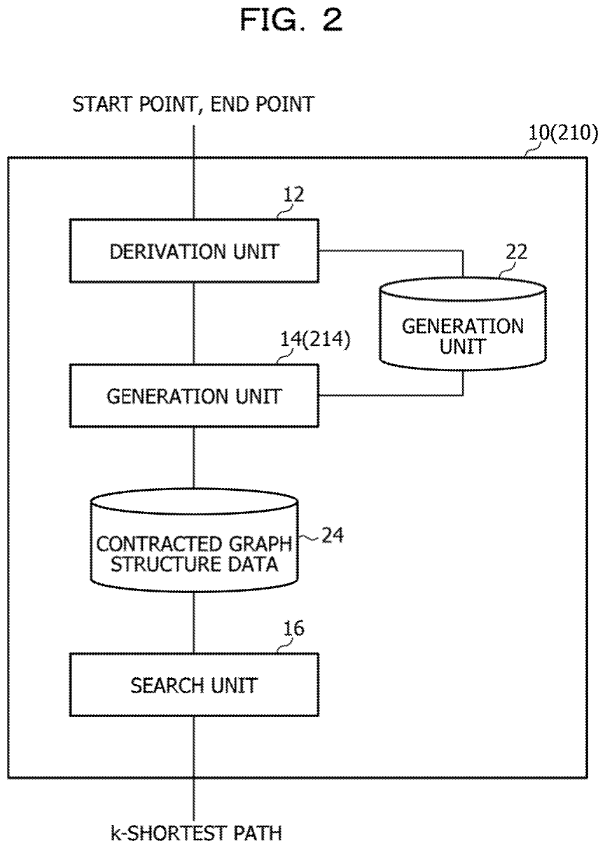

A shortest path search device 10 according to a first embodiment functionally includes a derivation unit 12, a generation unit 14, and a search unit 16 as illustrated in FIG. 2. Graph structure data 22 is stored in a predetermined storage area of the shortest path search device 10.

The graph structure data 22 is a graph including a plurality of vertices and a plurality of edges representing a coupling relationship between the vertices, and is data indicating the original graph described above. For example, information about the vertices and edges included in the original graph, are included. The information about the vertices includes a vertex number of each vertex. The information about the edges includes vertex numbers and weights of vertices at both ends of each edge. Hereinafter, the original graph indicated by the graph structure data 22 is represented by G=(V, E), V is a set of the vertices included in the original graph, and E is a set of the edges. The number of vertices is represented as n=|V|.

The derivation unit 12 obtains a first shortest path from a start point to each vertex included in the original graph and a second shortest path from an end point to each vertex included in the original graph. Based on the first shortest path and the second shortest path, the derivation unit 12 derives each of shortest passing paths that is the shortest path of paths from the start point to the second vertex with any of the vertices as a passing point. The start point is an example of “a first vertex” of the disclosed technology, and the end point is an example of “a second vertex”.

For example, the derivation unit 12 sets the start point of the k-shortest path to be obtained as vₛ and the end point as vₜ, and obtains shortest paths from each of the start point vₛ and the end point vₜ to all the vertices. Hereinafter, the shortest path obtained here is referred to as “an st-shortest path”, and a set of st-shortest paths is referred to as “an st-shortest path group”. st denotes a source (start point) and a target (end point).

For example, all vertices are set to v₁, v₂, . . . , vₙ. The derivation unit 12 calculates the shortest path from the start point vₛ to each of the other vertices vᵢ, and stores a distance from the start point vₛ to each of the vertices vᵢ in a predetermined storage area as a vector dₛ=[dₛⱼ]. Similarly, the derivation unit 12 calculates the shortest path from the end point vₜ to each of the other vertices vᵢ, and stores a distance from the end point vₜ to each of the vertices vᵢ as a vector dₜ=[dᵢⱼ]. dᵢⱼ represents a distance from the vertex vⱼ to the vertex vᵢ.

It is known that shortest paths from a certain vertex vᵢ to all other vertices, or shortest path from all other vertices to a certain vertex vᵢ are able to be represented as a shortest path tree, and the shortest path tree is able to be represented as a vector. Such a shortest path tree is stored in a predetermined storage area as a vector. For example, the shortest path tree from all the vertices to the vertex vᵢ is able to be represented by a vector [pⱼ] constituted by n pieces of elements. pⱼ is a vertex number of the next vertex of vⱼ in the path of the shortest path tree from vⱼ to vᵢ, and it is possible to obtain a shortest path from vⱼ to vᵢ by sequentially tracing the vertices.

Hereinafter, the shortest path from vₛ to vᵢ is represented by sp(vₛ, vᵢ), and the shortest path from vᵢ to vₜ is represented by sp(vᵢ, vₜ).

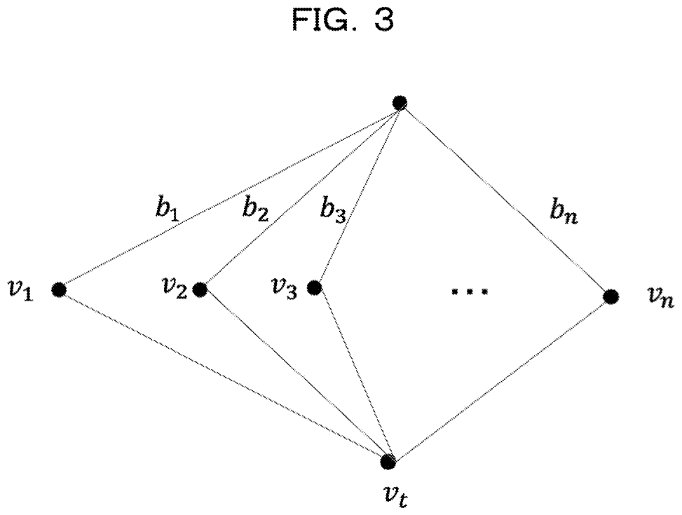

As illustrated in FIG. 3, the derivation unit 12 derives a path from the start point vₛ to the end point vₜ via each vertex vᵢ so as to pass through the shortest path from vₛ to vᵢ and the shortest path from vᵢ to vₜ. As described above, this path is referred to as “a shortest passing path” that passes vᵢ, and is represented by bᵢ. bᵢ is the shortest in the paths from vₛ to vₜ via vᵢ. When there is another shorter path, it violates that the path from vₛ to vᵢ and the path from vᵢ to vₜ on bᵢ are the shortest path. bₛ and bₜ are the shortest paths from vₛ to vₜ, and bₛ and bₜ coincide with each other.

The shortest passing path groups b₁, b₂, . . . , bₙ may be easily obtained once the shortest path from each of the start point and the end point to each vertex is obtained. The derivation unit 12 passes the derived shortest passing path groups b₁, b₂, . . . , bₙ to the generation unit 14.

The symbols used will be described below. Including the shortest path, the length (distance) of the path p is represented by d(p), and the distance between the vertices vᵢ and vⱼ is represented by d(vᵢ, vⱼ). For example, d(vᵢ, vⱼ)=dᵢⱼ. The length of the i-th shortest path of the k-shortest paths is represented by spdᵢ. The condition that the path p from vₛ to vₜ is the solution of the k-shortest path search is that the path p does not include a loop and satisfies d(p)≤spdₖ.

The generation unit 14 generates a contracted graph in which, among the shortest passing paths, vertices and edges that are not included in any of the shortest passing paths of top K2 (K2 is a positive integer greater than or equal to K1) having a short distance are removed from the original graph. In the following description, the description will be made assuming that K1=K2=k to simplify the description.

For example, the generation unit 14 excludes duplication for the same path included in the shortest passing path groups b₁, b₂, . . . , bₙ passed from the derivation unit 12. For example, the generation unit 14 sorts each of the shortest passing paths represented by a row of vertex numbers included in the path based on the vertex number row. The generation unit 14 compares between the shortest passing paths adjacent to each other in order from the top, and deletes one of the shortest passing paths when they are the same. The generation unit 14 may hash the vertex number row of each shortest passing path to exclude the duplication for each bucket.

The generation unit 14 sorts the shortest passing path groups bₕ₁, bₕ₂, . . . , b_{hn′} (n′≤n) from which the duplication is excluded in ascending order of the distance from vₛ to vₜ, for example, d(bᵢ). The sorted shortest passing path groups are denoted by bᵢ₁, bᵢ₂, . . . , b_{in′}. The generation unit 14 specifies vertices included in each of all the shortest passing paths from the top first shortest passing path of the shortest passing path groups bᵢ₁, bᵢ₂, . . . , b_{in′} to the top k-th shortest passing path excluding the shortest passing path that includes a low The generation unit 14 generates a contracted graph based on the specified vertices and the edges coupling between the specified vertices in the original graph.

For example, it is assumed that bᵢₑ is a top k-th shortest passing path excluding the shortest passing path that includes a loop. In this case, when a set of vertices included in bᵢ₁, bᵢ₂, . . . , bᵢₑ is V′, E′={(v, w)|(v, w)∈E, and v, w∈V′}, the graph G′=(V′, E′) is a contracted graph including the k-shortest path to be obtained. When there are less than k paths that do not include loops among the shortest passing path groups bᵢ₁, bᵢ₂, . . . , b_{in′}, since it means that the original graph may not be contracted, it is assumed that e=n′, for example, V′=V.

The generation unit 14 stores the contracted graph structure data 24 indicating the contracted graph G′ in a predetermined storage area.

A case where e<n′, for example, the original graph is able to be contracted is considered in here. Although bᵢ₁, bᵢ₂, . . . , bᵢₑ include k paths that are different from each other and do not include loops from vₛ to vₜ, they may not be the k-th shortest paths to be obtained. For example, spdₖ≤d(bᵢₑ). However, it is guaranteed that at least k paths that do not include loops are included in the contracted graph.

bᵢ₁, bᵢ₂, . . . , bᵢₑ also include the shortest passing path including a loop, and the reason will be described.

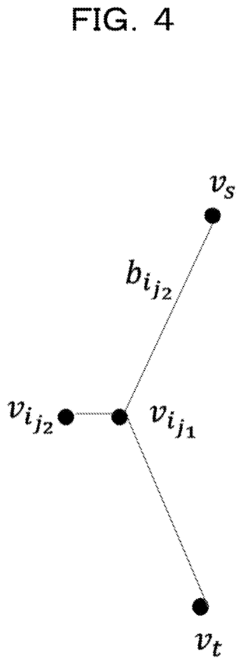

The shortest passing path bᵢⱼ₂ (j₂<e) including a loop illustrated in FIG. 4 is considered. The reason that j₂<e is that bᵢⱼₑ is a path that does not include a loop because bᵢ₁, bᵢ₂, . . . , bᵢₑ are extracted up to the top k-th shortest passing path excluding the shortest passing path that includes a loop. Since sp(vₛ, vᵢⱼ₂) and sp(vᵢⱼ₂, vₛ) share vᵢⱼ₁, a loop occurs. Vᵢⱼ₂ is adjacent to vᵢⱼ₁. For example, bᵢⱼ₂ is a path obtained by adding vᵢⱼ₂ to bᵢⱼ₁. Therefore, since d(bᵢⱼ₁)<d(bᵢⱼ₂), iⱼ₁<iⱼ₂.

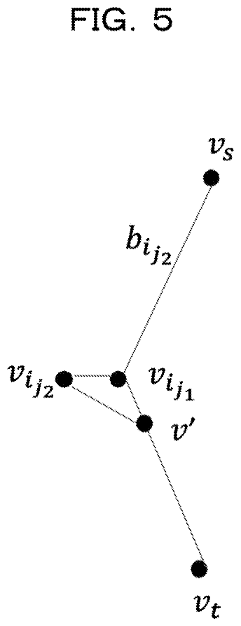

d(vᵢⱼ₁, vᵢⱼ₂) is assumed to be significantly short. As illustrated in FIG. 5, it is assumed that the vertex v′ exists on the shortest path from vₜ to vᵢⱼ₁, and d(vᵢⱼ₂, v′) is also significantly short. In this case, the path p from vₛ to vₜ via vᵢⱼ₁, vᵢⱼ₂, v′ is slightly longer than bᵢⱼ₁. Assuming that bᵢⱼ₂₊₁ is much longer than bᵢⱼ₁, then d(p)<d(bᵢⱼ₂₊₁). This means that the path p is shorter than the k-th shortest passing path. Since the vertex of the k-th shortest passing path is also included in V′, vᵢⱼ₂ may also be included in V′. This is the reason why bᵢ₁, bᵢ₂, . . . , bᵢₑ include a shortest passing path that includes a loop.

It is able to be proved as follows that he contracted graph G′=(V′, E′) includes the k-shortest path to be obtained.

With respect to bᵢ₁, bᵢ₂, . . . , bᵢₑ, when e=n′, it means that the original graph is not able to be contracted, so that it is sufficient to prove the case of e<n′. Set V′ be a set of vertices included in bᵢ₁, bᵢ₂, . . . , bᵢₑ. The shortest passing path including a loop is excluded from bᵢ₁, bᵢ₂, . . . , bᵢₑ, and b′₁, b′₂, b′ₖ are set by sorting in ascending order of distance. As described above, b′ₖ satisfies spdₖ≤d(b′ₖ).

A vertex v that is not included in V′ is considered. When it is said that there is no path that satisfies d(p)<spdₖ in the path p from vₛ to vₜ via v, there is no problem even when v is not included in V′, and thus it is proved.

A shortest passing path b that passed v is considered. As described above, it may satisfies d(b)≤d(p) and d(b′ₖ)≤d(b). This is because when d(b′ₖ)>d(b) b is included in b′₁, b′₂, . . . , b′ₖ. As described above, since spdₖ≤d(b′ₖ), spdₖ≤d(b). For example, it means that it is spdₖ≤d(p), and p that satisfies d(p)<spdₖ does not exist.

The search unit 16 searches for a k-shortest path by applying any existing k-shortest path search method to the contracted graph G′ indicated by the contracted graph structure data 24, and outputs the searched k-shortest path.

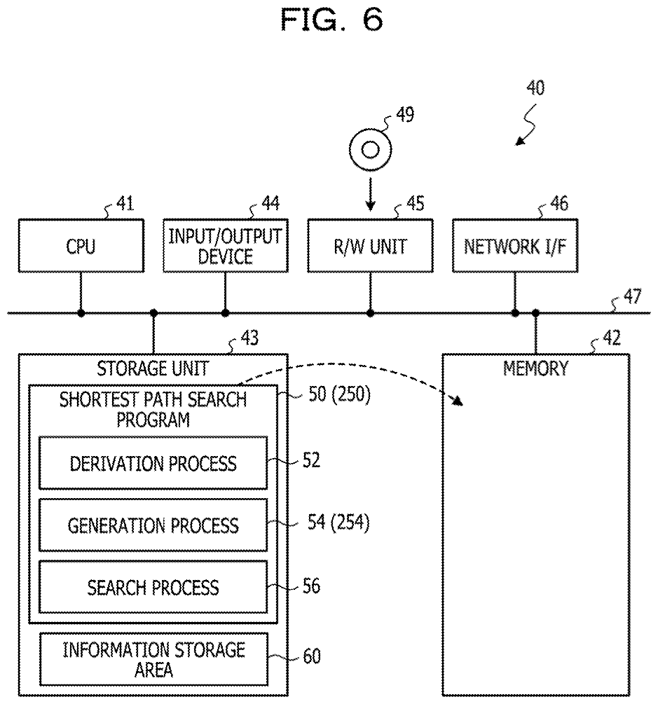

The shortest path search device 10 is able to be realized by, for example, a computer 40 illustrated in FIG. 6. The computer 40 includes a central processing unit (CPU) 41, a memory 42 serving as a temporary storage area, and a storage unit 43 that is nonvolatile. The computer 40 also includes an input/output device 44 such as an input unit and a display unit, and a read/write (R/W) unit 45 that controls reading and writing of data from and to a storage medium 49. The computer 40 also includes a communication interface (I/F) 46 that is coupled to a network such as the Internet. The CPU 41, the memory 42, the storage unit 43, the input/output device 44, the R/W unit 45, and the communication I/F 46 are coupled to each other via a bus 47.

The storage unit 43 may be realized by a hard disk drive (HDD), a solid state drive (SSD), a flash memory, or the like. The storage unit 43 as a storage medium stores a shortest path search program 50 that causes the computer 40 to function as the shortest path search device 10. The shortest path search program 50 includes a derivation process 52, a generation process 54, and a search process 56. The storage unit 43 includes an information storage area 60 in which the graph structure data 22 and the contracted graph structure data 24 are stored.

The CPU 41 reads the shortest path search program 50 from the storage unit 43, loads the shortest path search program 50 to the memory 42, and sequentially executes the processes included in the shortest path search program 50. The CPU 41 operates as the derivation unit 12 illustrated in FIG. 2 by executing the derivation process 52. The CPU 41 also operates as the generation unit 14 illustrated in FIG. 2 by executing the generation process 54. The CPU 41 also operates as the search unit 16 illustrated in FIG. 2 by executing the search process 56. The CPU 41 reads the graph structure data 22 from the information storage area 60 and loads the original graph G indicated by the graph structure data 22 in the memory 42. The CPU 41 stores the contracted graph G′ in the memory 42 in the information storage area 60 as the contracted graph structure data 24, reads the contracted graph structure data 24 from the information storage area 60, and loads the contracted graph G′ over the memory 42. In this way, the computer 40 executing the shortest path search program 50 functions as the shortest path search device 10. The CPU 41 that executes the program is hardware.

The functions realized by the shortest path search program 50 may also be realized by, for example, a semiconductor integrated circuit, more specifically, an application-specific integrated circuit (ASIC) or the like.

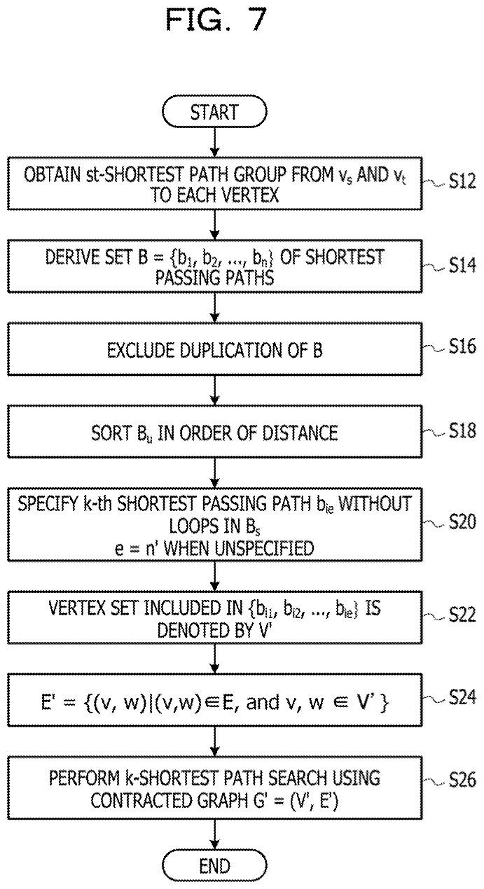

An operation of the shortest path search device 10 according to the first embodiment will be described next. When the start point vₛ and the end point vₜ are designated from the vertices included in the original graph, the shortest path search device 10 executes a shortest path search process illustrated in FIG. 7, The shortest path search process is an example of a shortest path search method of the disclosed technology. A case where the vertex 1 is designated as the start point vₛ and the vertex 9 is designated as the end point vₜ in the original graph illustrated in the left diagram in FIG. 1 will be described as an example.

In step S12, the derivation unit 12 obtains an st-shortest path group from each of vₛ and vₜ to each vertex.

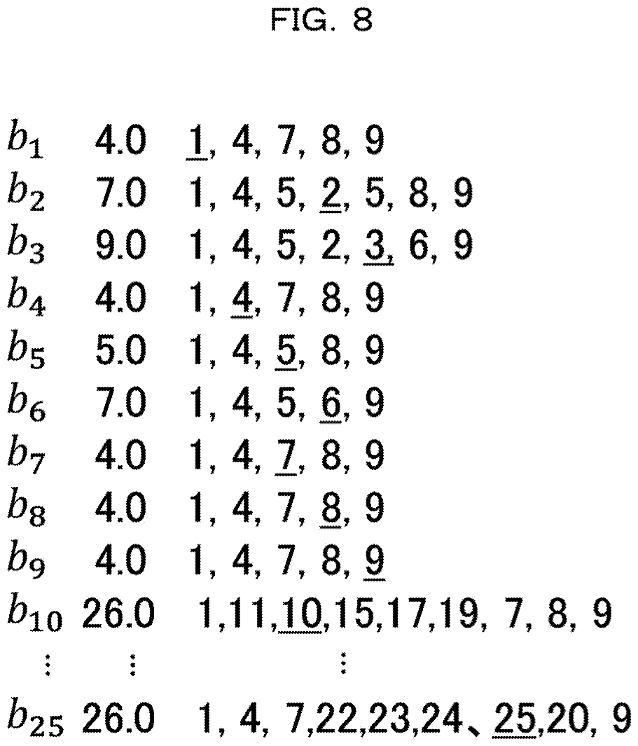

Next, in step S14, the derivation unit 12 derives a set B={b₁, b₂, . . . , bₙ} of shortest passing paths using the st-shortest path groups. FIG. 8 illustrates an example of the set B of shortest passing paths. In FIG. 8, the numerical value of the next row of bᵢ is d(bᵢ), and the vertex number row of the next row is the shortest passing path. The underlined vertex number indicates a vertex number selected as a vertex to be passed through (passing point).

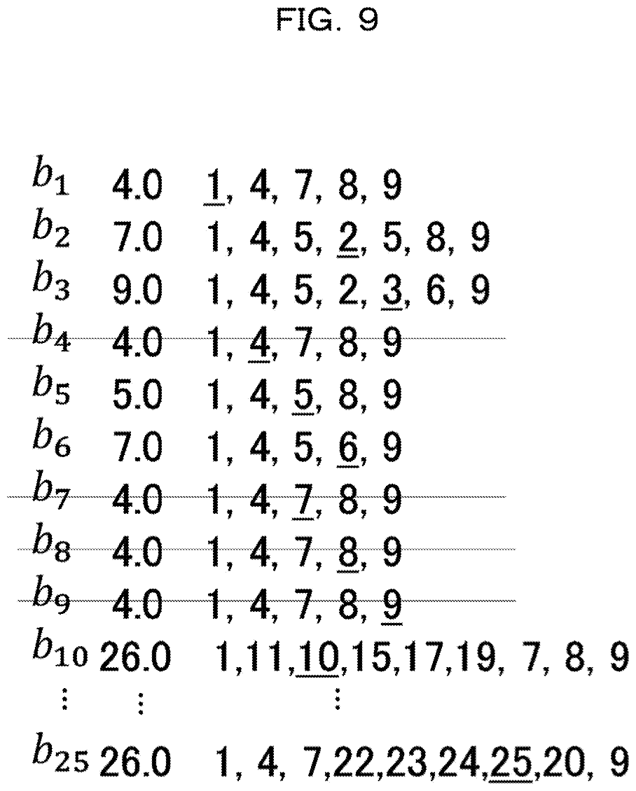

Next, in step S16, the generation unit 14 excludes duplication of B by using sorting or hashing, and sets a set of results as Bᵤ={bₕ₁, bₕ₂, . . . , b_{hn′}}(n′≤n). FIG. 9 illustrates an example of a set Bᵤ of shortest passing paths from which duplicates are excluded. In FIG. 9, the shortest passing paths canceled by the cancel line are the shortest passing paths excluded due to the duplication.

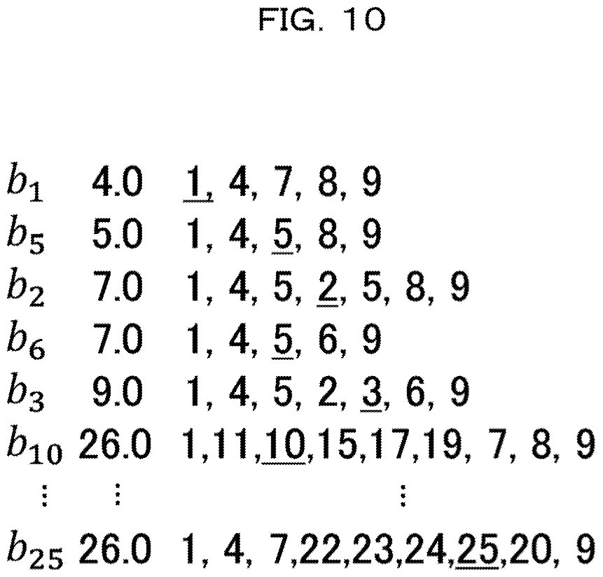

Next, in step S18, the generation unit 14 sorts Bᵤ in ascending order of distance, and sets a row of the result as Bₛ={bᵢ₁, bᵢ₂, . . . , bᵢₙ} (n′≤n). FIG. 10 illustrates an example of the set Bₛ of shortest passing paths sorted in ascending order of distance.

Next, in step S20, the generation unit 14 specifies the top k-th shortest passing path bᵢₑ excluding the shortest passing path that includes a loop in Bₛ. When it is not able to be specified, it is set to e=n′. When it is set to k=3, in the example in FIG. 10, since b₂ includes a loop, b₆ is specified as bᵢₑ.

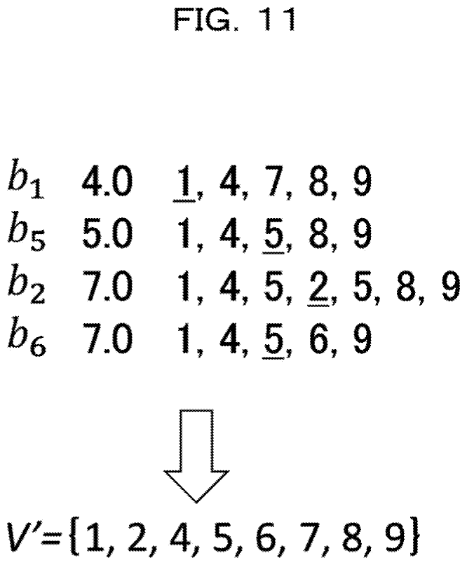

Next, in step S22, the generation unit 14 sets a set of vertices included in bᵢ₁, bᵢ₂, . . . , bᵢₑ as V′. FIG. 11 illustrates examples of bᵢ₁, bᵢ₂, . . . , bᵢₑ and V′.

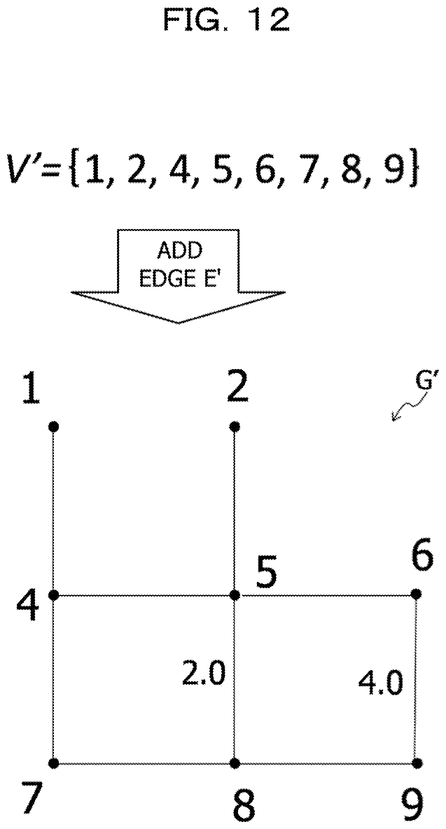

Next, in step S24, the generation unit 14 generates a contracted graph G′=(V′, E′) as E′={(v, w)|(v, w)∈E, and v, w∈V′}, and stores the contracted graph structure data 24 indicating the contracted graph G′ in a predetermined storage area. FIG. 12 illustrates the contracted graph G′ generated by adding an edge to V′.

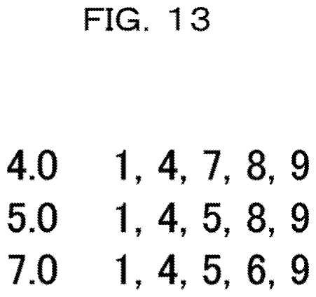

Next, in Step S26, the search unit 16 searches for a k-shortest path by applying any existing k-shortest path search method to the contracted graph G′ indicated by the contracted graph structure data 24, and outputs the searched k-shortest path. Thereafter, the shortest path search process is terminated. FIG. 13 illustrates the 3-shortest path searched from the contracted graph G′ illustrated in FIG. 12.

As described above, the shortest path search device according to the first embodiment obtains a first shortest path from a start point to each vertex included in the original graph and a second shortest path from an end point to each vertex included in the original graph. Based on the first shortest path and the second shortest path, the shortest path search device derives each of shortest passing paths from the start point to the end point with any of the vertices as a passing point. Thereafter, the shortest path search device generates a contracted graph in which, among the shortest passing paths from which duplicated paths are excluded, vertices and edges that are not included in any of the shortest passing paths of top k having a short distance are removed from the original graph. The shortest path search device performs the k-shortest path search process by applying any existing method to the contracted graph. In this way, the processing cost of the k-shortest path search is able to be reduced.

### Second Embodiment

Next, a second embodiment will be described. In a shortest path search device according to the second embodiment, configurations that are substantially the same as those of the shortest path search device 10 according to the first embodiment are denoted by the same reference numerals, and a detailed description thereof will be omitted.

In the GR(E) method according to the first embodiment, the processing cost of a portion for excluding duplication from the derived shortest passing paths is high. Therefore, in the second embodiment, a method of generating a contracted graph without performing the process of excluding the duplication will be described.

A shortest path search device 210 according to the second embodiment functionally includes a derivation unit 12, a generation unit 214, and a search unit 16 as illustrated in FIG. 2. Graph structure data 22 is stored in a predetermined storage area of the shortest path search device 10.

The generation unit 214 sets the shortest passing path derived by the derivation unit 12 as a shortest passing path of a processing target in order from the top first shortest passing path group which is sorted in ascending order of distance, and adds a vertex included in the shortest passing path of the processing target to the vertex set included in the contracted graph. The generation unit 214 generates a contracted graph based on the vertices included in the vertex set when the process of removing the shortest passing path having the vertex added to the vertex set as the passing point from the shortest passing path group is repeated k times. The method of generating the contracted graph is the same as that of the first embodiment.

When the shortest passing path of the processing target includes a loop, the generation unit 214 adds only the passing point included in the shortest passing path of the processing target to the vertex set, and does not add the number of repeated times of the process.

The shortest path search device 210 is able to be realized by, for example, a computer 40 illustrated in FIG. 6. The storage unit 43 of the computer 40 stores a shortest path search program 250 that causes the computer 40 to function as the shortest path search device 210. The shortest path search program 50 includes a derivation process 52, a generation process 254, and a search process 56.

The CPU 41 reads the shortest path search program 250 from the storage unit 43, loads the shortest path search program 250 to the memory 42, and sequentially executes the processes included in the shortest path search program 250. The CPU 41 operates as the generation unit 214 illustrated in FIG. 2 by executing the generation process 254. The other processes are substantially the same as those of the shortest path search program 50 according to the first embodiment. In this way, the computer 40 executing the shortest path search program 250 functions as the shortest path search device 10.

The functions that are realized by the shortest path search program 250 may also be realized by, for example, a semiconductor integrated circuit, more specifically an ASIC or the like.

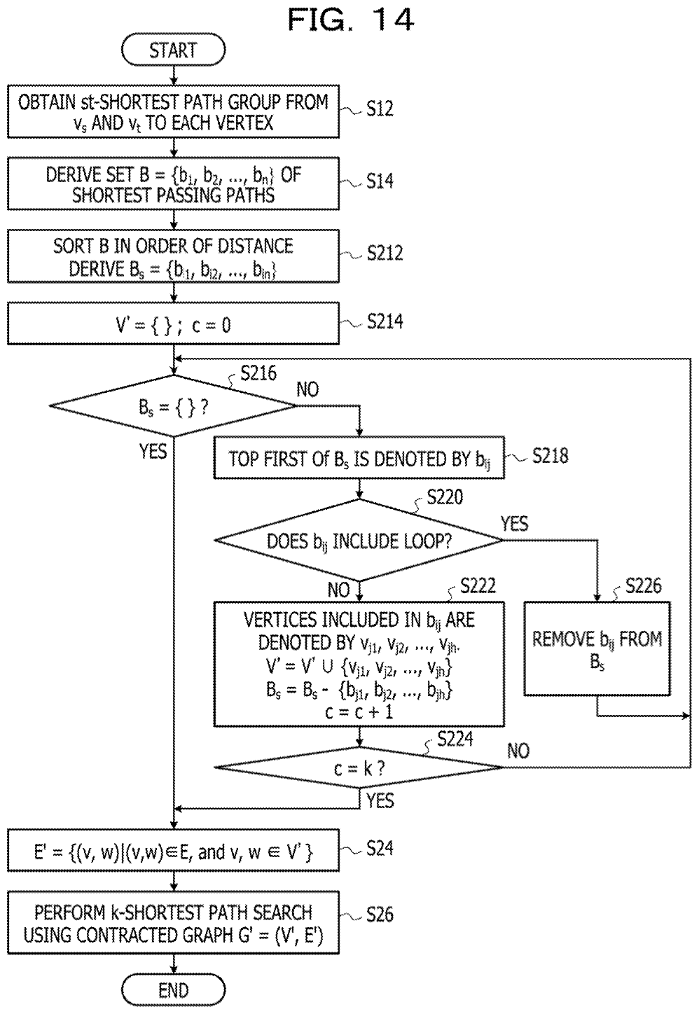

An operation of the shortest path search device 210 according to the second embodiment will be described next. When the start point vₛ and the end point vₜ are designated from the vertices included in the original graph, the shortest path search device 210 executes a shortest path search process illustrated in FIG. 14. In a shortest path search process according to the second embodiment, a process that are substantially the same as those of the shortest path search process according to the first embodiment are denoted by the same step numbers, and a detailed description thereof will be omitted. Similar to the first embodiment, a case where the vertex 1 is designated as the start point vₛ and the vertex 9 is designated as the end point vₜ in the original graph illustrated in the left diagram in FIG. 1 will be described as an example.

In steps S12 and S14, the derivation unit 12 derives a set B={b₁, b₂, . . . , bₙ} of the shortest passing paths as illustrated in FIG. 8.

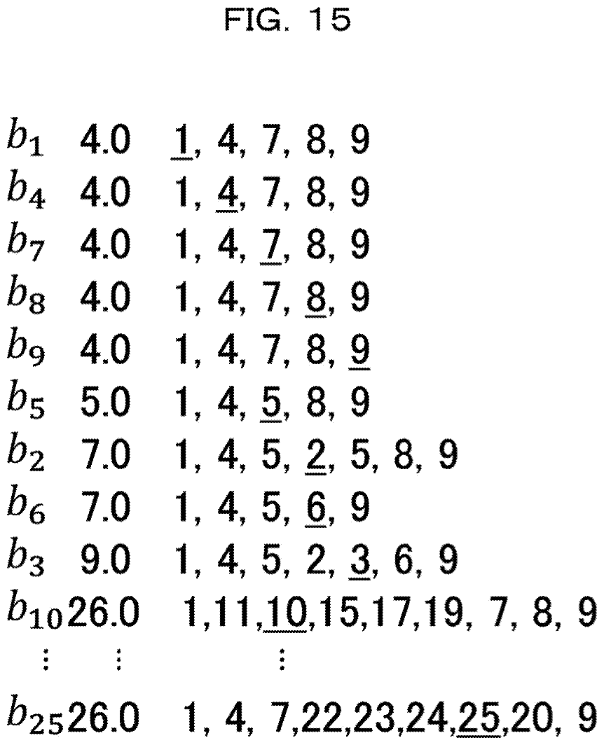

Next, in step S212, the generation unit 214 sorts the set B of the shortest passing paths in ascending order of distance, and sets the result as a row Bₛ={bᵢ₁, bᵢ₂, . . . , bᵢₙ}. FIG. 15 illustrates an example of the set Bₛ of shortest passing paths sorted in ascending order of distance.

Next, in step S214, the generation unit 214 prepares an empty set as a set V′ of vertices included in the contracted graph. The generation unit 214 sets a counter c for counting the shortest passing paths that do not include loops to 0.

Next, in step S216, the generation unit 214 determines whether or not Bₛ is empty. When Bₛ is empty, the process proceeds to step S24, and when there is a shortest passing path remaining in Bₛ, the process proceeds to step S218.

In step S218, the generation unit 214 sets the top first shortest passing path of Bₛ to the shortest passing path bᵢⱼ of the processing target.

Next, in step S220, the generation unit 214 determines whether or not the shortest passing path bᵢⱼ of the processing target includes a loop. When bᵢⱼ does not include a loop, the process proceeds to step S222, and when bᵢⱼ includes a loop, the process proceeds to step S226.

In step S222, the generation unit 214 sets the vertices included in bᵢⱼ to vⱼ₁, vⱼ₂, . . . , vⱼₕ, and adds vⱼ₁, vⱼ₂, . . . , vⱼₕ to V′. The generation unit 214 removes bⱼ₁, bⱼ₂, . . . , bⱼₕ from Bₛ. The generation unit 214 increments the counter c by 1, and the process proceeds to step S224.

On the other hand, in step S226, the generation unit 214 adds only vᵢⱼ to V′ and removes bᵢⱼ from Bₛ, and the process returns to step S216.

In step S224, the generation unit 214 determines whether or not the counter c is k. When c=k, the process proceeds to step S24, and when c≠k, the process returns to step S216.

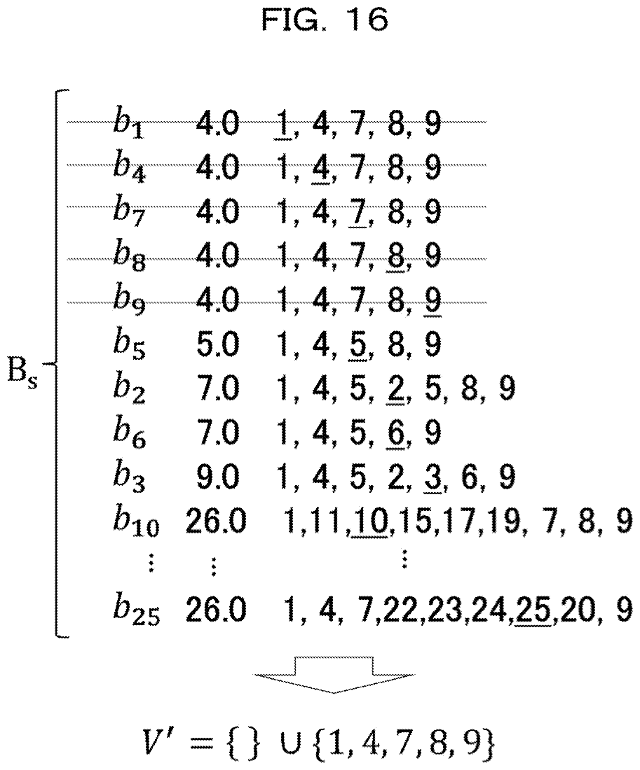

The process of steps S216 to S224 will be described in more detail with k=3. When the process is performed for the first time, Bₛ is in a state illustrated in FIG. 15, a negative determination is made in step S216, and b₁ is selected as a shortest passing path of the processing target in step S218. Since b₁ does not include a loop, in step S222, as illustrated in FIG. 16, the shortest passing paths b₁, b₄, b₇, b₈, and b₉ with the vertices v₁, v₄, v₇, v₈, and v₉ included in b₁ as passing points are removed from Bₛ. The vertices v₁, v₄, v₇, v₈, and v₉ are added to V′. Thereafter, c=1.

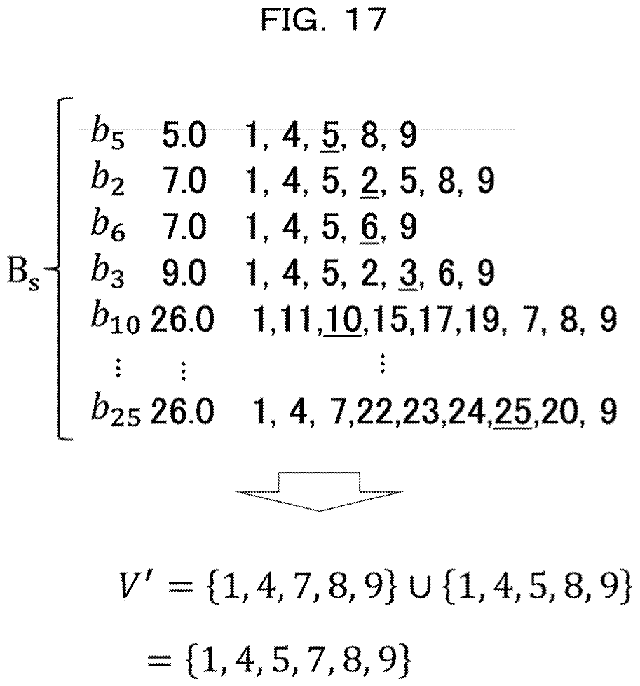

Returning to step S216, when the process is performed for the second time, in step S218, b₅ is selected as a shortest passing path of the processing target. Since b₅ does not include a loop, in step S222, as illustrated in FIG. 17, the shortest passing paths b₁, b₄, b₅, b₈, and b₉ with the vertices v₁, v₄, v₅, v₈, and v₉ included in bₛ as passing points are removed from Bₛ. Since b₁, b₄, b₈, and b₉ are already removed from Bₛ, b₅ is removed here. The vertices v₁, v₄, v₅, v₈, and v₉ are added to V′. Since v₁, v₄, v₈, and v₉ are already added to V′, v₅ is newly added here. Thereafter, c=2.

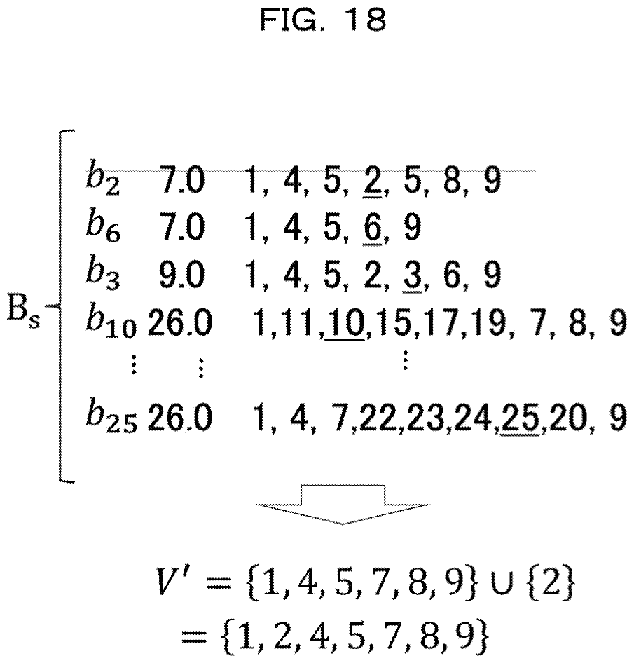

Returning to step S216, when the process is performed for the third time, in step S218, b₂ is selected as a shortest passing path of the processing target. Since b₂ includes a loop, in step S226, as illustrated in FIG. 18, b₂, which is the shortest passing path of the processing target, is removed from Bₛ. v₂, which is a passing point of b₂, is added to V′. Thereafter, c=2 is maintained.

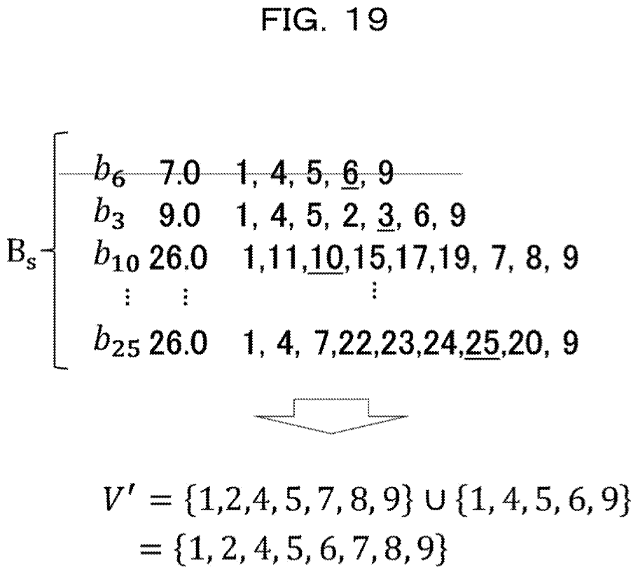

Returning to step S216, when the process is performed for the fourth time, in step S218, b₆ is selected as a shortest passing path of the processing target. Since b₆ does not include a loop, in step S222, as illustrated in FIG. 19, the shortest passing paths b₁, b₄, b₅, b₆, and b₉ with the vertices v₁, v₄, v₅, v₆, and v₉ included in b₆ as passing points are removed from Bₛ. Since b₁, b₄, b₅, and b₉ are already removed from Bₛ, b₆ is removed. The vertices v₁, v₄, v₅, v₆, and v₉ are added to V′. Since v₁, v₄, v₅, and v₉ are already added to V′, v₆ is newly added here. Thereafter, c=3.

At this stage, c=k, and a contracted graph as illustrated in FIG. 12 is generated based on the vertices currently included in V′.

Although the first embodiment and the second embodiment differ in the method of generating the contracted graph, the same contracted graph is generated. The reason for this will be described.

The process of step S222 corresponds to the process of excluding the duplication of the derived shortest passing paths in the first embodiment. The process of step S226 corresponds to the derivation process of including the vertex of the shortest passing path that includes a loop in V′ in the first embodiment.

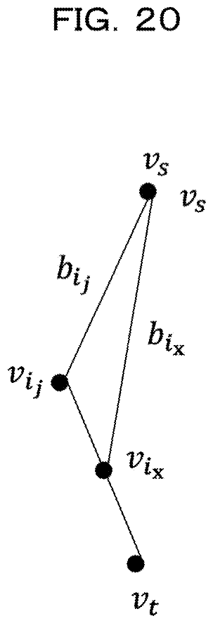

First, the process of step S222 will be described. The vertices included in bᵢⱼ are set to vⱼ₁, vⱼ₂, . . . , vⱼₕ. Although bᵢⱼ is the shortest passing path using vᵢⱼ as a passing point, vⱼ₁ is equal to vᵢⱼ, for example, j₁=iⱼ. Although vⱼ₁, vⱼ₂, . . . , vbⱼₕ also include vₛ and vₜ, a vertex vᵢₓ as illustrated in FIG. 20, which is not vⱼ₁, vₛ, or vₜ, is considered. In this case, d(bᵢⱼ)=d(bᵢₓ). Because bᵢⱼ is the top first shortest passing path of Bₛ, being d(bᵢⱼ)≤d(bᵢₓ), d(bᵢⱼ)<d(bᵢₓ) means that a distance from vₛ to vᵢₓ in bᵢₓ is longer than a distance from vₛ to vᵢₓ in bᵢⱼ. This violates that the distance from vₛ to vᵢₓ in bᵢₓ is the shortest. This means that bᵢₓ may be exactly the same as bᵢⱼ. For example, it means that bᵢₓ may be deleted as a duplicate.

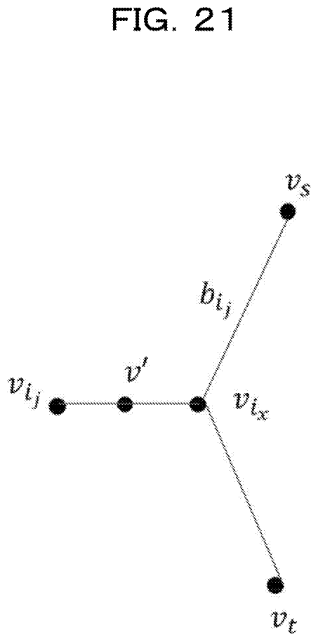

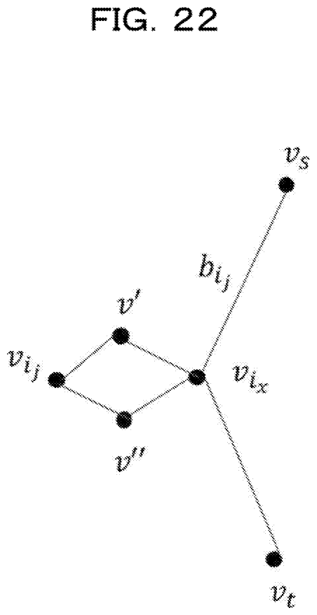

Next, the process of step S226 will be described. In step S226, only vᵢⱼ is added to V′. Even in a situation as illustrated in FIG. 21, for example, even when v′ other than vᵢⱼ is included in a loop, v′ may not be added to V′. This is because v′ is already added to V′ since d(b(v′))<d(bᵢⱼ). In the example in FIG. 21, the loop is linear, but the same applies to the case of a circular loop as illustrated in FIG. 22. This is because, since a distance of the path from vᵢₓ to vᵢⱼ via v′ and a distance of the path from vᵢₓ to vᵢⱼ via v″ are the same, d(b(v′))<d(bᵢⱼ) and d(b(v″)<d(bᵢⱼ) are established.

In the second embodiment, there is a possibility that a more contracted graph may be generated as compared with the case of the first embodiment. With the algorithm of the first embodiment and the algorithm of the second embodiment, regarding the number of vertices included in the contracted graph, there is no difference in the process related to the shortest passing paths including loops, but differences occur in the relationship in the process of excluding of duplicated shortest passing paths.

The reason why the number of vertices included in the contracted graph is the same in the process related to the shortest passing paths including loops is as follows. First, the shortest passing paths including loops are completely the same in both algorithms. However, in the algorithm of the first embodiment, all the vertices in the shortest passing paths including loops are included in the contracted graph. In the algorithm of the second embodiment, only vᵢⱼ is added as the vertex of the contracted graph when adding the shortest passing path bᵢⱼ having the vertex vᵢⱼ as a passing point. As described above, the vertices between vᵢⱼ and vᵢₓ illustrated in FIGS. 21 and 22 are already added as vertices of the contracted graph before that. Since the shortest passing path bᵢₓ of vᵢₓ already appeared before bᵢⱼ, the vertex thereof is also added. For example, the same vertices are eventually added to the contracted graph. The above is the reason why there is no difference in the number of vertices for the shortest passing paths including loops in both algorithms.

The reason why there is a difference in the number of vertices included in the contracted graph in relation to the process of excluding the duplicated shortest passing paths is as follows. In FIG. 20, bᵢⱼ and bᵢₓ are regarded as a duplicate in the algorithm of the second embodiment. On the other hand, in the algorithm of the first embodiment, when the st-shortest path group is calculated, the distances are the same, but there is a possibility that the distances are calculated as different paths. In that case, the number of vertices in the contracted graph is increased in the algorithm of the first embodiment. This is the reason why the number of vertices of the contracted graph may increase in the first embodiment.

As described above, the shortest path search device according to the second embodiment does not perform the process of excluding the duplication of the derived shortest passing paths when generating the contracted graph from the original graph. Accordingly, the processing cost of k-shortest path search is able to be further reduced as compared with the shortest path search device according to the first embodiment.

A comparison result of performance between the two methods in the related art and the method of the present embodiment will be described. One of the methods in the related art is a method of obtaining a shortest path different from an already obtained shortest path by obtaining the shortest path in a graph from which edges included in the already obtained shortest path are removed (hereinafter, referred to as a “Yen method”). The other method in the related art is a method in which the Dijkstra method is extended to a k-shortest path (hereinafter, referred to as “k-Dij”). The k-Dij used in the following performance comparison is a method obtained by improving the algorithm described in [K-shortest] below. The method of the present embodiment is GR(k-Dij) in which k-Dij is applied to the existing k-shortest path search.

[K-shortest]: k shortest path routing, https://en.wikipedia.org/wiki/K_shortest_path_routing

When the Yen method, and k-Dij and GR(k-Dij) are compared with k=√n, the processing speed of k-Dij is faster than that of the Yen method, and thus only the result of comparison between k-Dij and GR(k-Dij) is described below.

A scale-free graph, which is said to be ubiquitous in the real world, is used as the original graph. The number of vertices n is measured at n=2²ⁱ(i=3, 4, 5, 6, 7), for example, n=64, 256, 1024, 4096, 16384. In a case of generating a scale-free graph, when a graph constituted by n vertices is generated, a complete graph G=(V, E) constituted by n′ (<n) vertices is generated first. Secondly, the remaining n-n′ vertices are added one by one. One of the remaining n-n′ vertices is set to v. When n′ vertices that are randomly selected from V are denoted by v₁, v₂, . . . , v_{n′}, V=V ∪{v} and E=E∪{(v, v₁), (v, v₂), . . . , (v, v_{n′})}. The probability of selecting vᵢ (i=1, 2, . . . , n′) is proportional to the order of vᵢ.

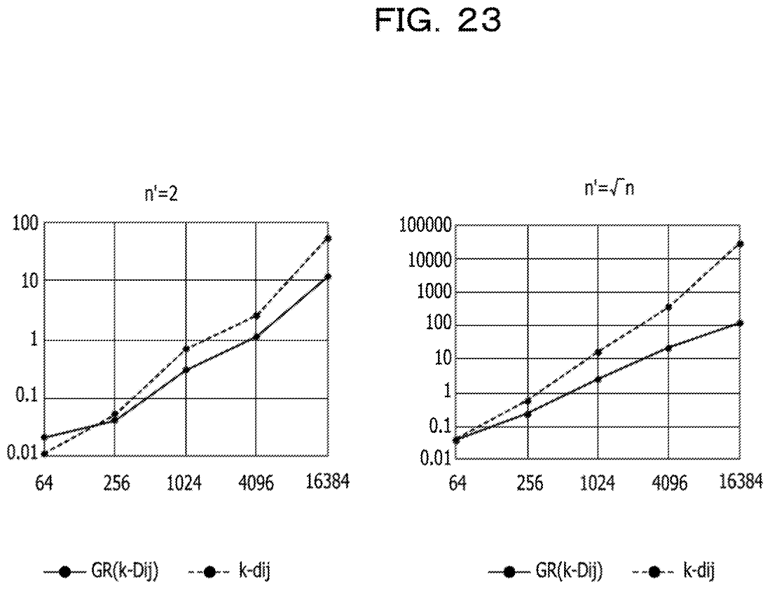

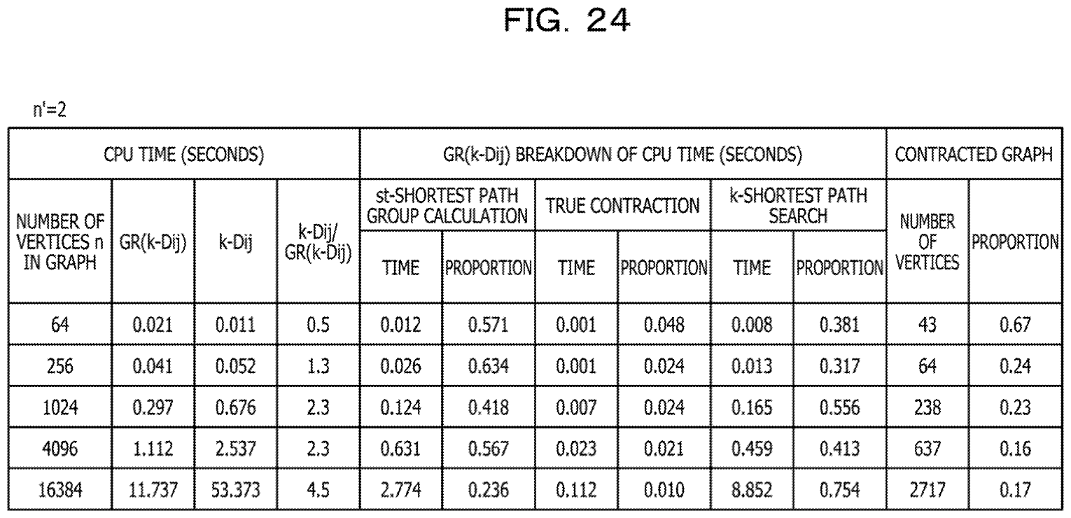

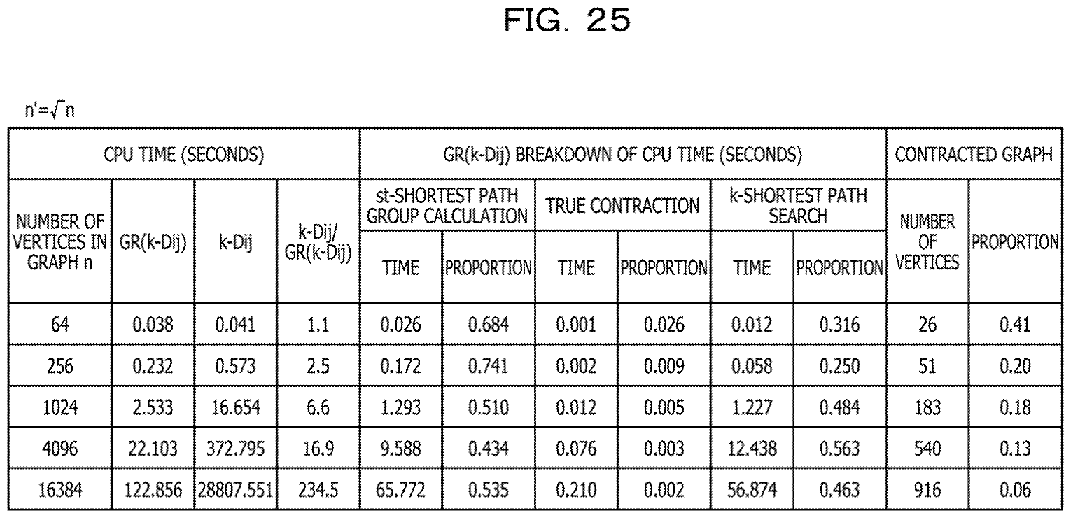

FIG. 23 is a scale-free graph in which the CPU times of k-Dij and GR(k-Dij) are compared using both logarithmic graphs when n′=2 and n″=√n, for example, when the graph is sparse and dense. FIG. 24 and FIG. 25 illustrate a summary of the comparison of the CPU times of both formulas, the breakdown of CPU time of the GR(k-Dij), and the number of vertices of the contracted graph.

The rows of k-Dij/GR(k-Dij) in FIGS. 24 and 25 represent the ratio of the CPU time of k-Dij with respect to the CPU time of GR(k-Dij), for example, how many times GR(k-Dij) is faster than k-Dij. The breakdown of the CPU time of GR (k-Dij) is that the CPU time that is desired by GR(k-Dij) is divided into three of st-shortest path group calculation, graph contraction based on the st-shortest path group calculation, and k-shortest path search by k-Dij to the contracted graph. In the above embodiment, the process up to generating the contracted graph includes the process of obtaining the st-shortest path group, but here, in order to describe that the process of obtaining the st-shortest path group is not included, it is referred to as a “true contraction” of a graph.

In the case of n=16384, when n′=2, GR(k-Dij) is substantially 4.5 times larger than k-Dij, but when n′=√n, GR(k-Dij) is substantially 230 times larger than k-Dij. It is seen that when n′ is large, for example, the graph is dense, the performance difference becomes remarkable.

For the values of k-Dij/GR(k-Dij) in. FIG. 24 and FIG. 25, the ratio increases as n increases in both n′=2 and n′=√n. The proportion of the true contraction portion is small for both n′=2 and √n, and it may be said that the algorithm for the true contraction portion is fast.

Looking at the number of vertices in the contracted graph, it may be seen that when n′=√n, for example, the graph is dense, it is more contracted than when n′=2, for example, the graph is sparse. This is considered to be the reason why the value of k-Dij/GR(k-Dij) is larger when n′=√n than when n′=2.

From the above comparison results, it may be expected that the method according to the present embodiment is more effective for a graph having a heavy processing load and a long time, such as a dense graph.

Most of the time desired to obtain the contracted graph is the calculation of the st-shortest path, and the time desired for the true contraction of the graph is short. In that sense, the algorithm for the true contraction portion may be said to be fast. This point is important because the effect of the GR method is diminished when it takes a long time for the true contraction.

The algorithm of the second embodiment is not only faster than the algorithm of the first embodiment, but as described above, it is also advantageous in that the number of vertices included in the generated contracted graph is equal to or less than the number of vertices in the contracted graph generated by the algorithm of the first embodiment.

In each of the above-described embodiments, the coupled weighted undirected graph has been described, but the present disclosure is not limited to this, and the disclosed technology may be applied to the following three types of combinations.

First, the unweighted graph, whether it is an undirected graph or a directed graph, is regarded as a graph in which all the edge weights are 1, so that the disclosed technology is able to be applied.

In a directed graph, with or without weighting, when obtaining the shortest path from the start point to all vertices and obtaining the shortest path from all vertices to the end point, it is possible that either the shortest path from the start point to all the vertices or the shortest path from all the vertices to the end point may not be found for a certain vertex v. In that case, the disclosed technology is able to be applied by not obtaining the shortest passing path for v and by not inserting v into V′.

As described above, it has been described that the disclosed technology is able to be applied to all four combinations of the undirected graph and the directed graph, and the weighted graph and the unweighted graph.

### Non-coupled Graph

In each of the above-described embodiments, the description has been made on the premise of the coupled graph, but the disclosed technology is able to be applied to a non-coupled graph. In the case of a non-coupled graph, when the start point and the end point are included in the same coupled component, a solution may be obtained by applying the disclosed technology. Otherwise, no solution may be obtained.

In each of the above embodiments, when the start point and the end point are designated, for example, when the process of k-shortest path search is executed, although the case of performing st-shortest path group calculation and contracted graph generation has been described, the present disclosure is not limited to this. By performing each process in advance, the processing time at the time of k-shortest path search is able to be further shortened.

For example, the st-shortest path group that occupies most of the processing time in each of the above embodiments is calculated in advance and stored in the secondary memory or the main memory, so that it is possible to reduce the processing time when the k-shortest path search is performed.

When the value used as the value of k is assumed to be up to substantially kₘₐₓ, by performing kₘₐₓ-shortest path search in advance and storing the contracted graph, it is possible to omit the processes of st-shortest path group calculation and contracted graph generation.

The method of calculating the st-shortest path group in advance is, for example, effective when the occupied proportion of the calculation of the st-shortest path group to the entire process is high. For example, as illustrated in FIG. 25, when n′=√n and n=256, the occupied proportion of the st-shortest path calculation is as high as 74%, and GR(k-Dij) that took 0.232 seconds may be speeded up to 0.058 seconds, which is four times faster. Therefore, in the k-shortest path search, 0.573 seconds becomes 0.232 seconds, which is only substantially 2.5 times faster, but by calculating in advance, it is seen that the speed is substantially 10 times as fast as 0.058 seconds and the effect is great.

In each of the above-described embodiments, K1 which is the number of solutions in the k-shortest path search and K2 which is the number of shortest passing paths not including loops included in the contracted graph are both described as k. However the present disclosure is not limited to this, and it is sufficient when K1≤K2, and different values may be set.

In the embodiment described above, although an aspect of the embodiment has been described in which the shortest path search program is stored (installed) in a storage unit in advance, the aspect is not limited thereto. The program according to the disclosed technology is able to be provided in a form stored in a storage medium such as a compact disc read-only memory (CD-ROM), a digital versatile disc (DVD)-ROM, or a Universal Serial Bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a shortest path search program that causes a computer to execute a process of K1-shortest path search (K1 is a positive integer) from a first vertex to a second vertex in graph structure data that includes a plurality of vertices and a plurality of edges representing a coupling relationship between the vertices, the process comprising:
based on a shortest path from the first vertex to respective vertices included in the plurality of vertices and a shortest path from the second vertex to the respective vertices included in the plurality of vertices, deriving each of one or more shortest passing paths which are shortest paths of paths from the first vertex to the second vertex using any of the respective vertices as a passing point;
generating contracted graph structure data in which, among the shortest passing paths, vertices and edges that are not included in any of the shortest passing paths of K2 (K2 is a positive integer greater than or equal to K1) paths having a distance less than a threshold value are removed from the graph structure data; and
performing the process of K1-shortest path search with respect to the contracted graph structure data.

2. The non-transitory compute readable storage medium according to claim 1, further comprising:
excluding derived shortest passing paths that are duplicates and specifying the shortest passing paths included in the K2 paths by sorting remaining shortest passing paths in ascending order of distance.

3. The non-transitory computer-readable storage medium according to claim 2, further comprising:
specifying vertices included in each of all the shortest passing paths from a first shortest passing path sorted in the ascending order of distance to the K2-th shortest passing path excluding a shortest passing path that includes a loop; and
the generating generates the contracted graph structure data based on an edge that couples the specified vertices, and the specified vertices in the graph structure data.

4. The non-transitory computer-readable storage medium according to claim 1, further comprising:
setting shortest passing path groups obtained by sorting the derived shortest passing paths in ascending order of distance, each of the shortest passing path groups includes a plurality of shortest passing paths of a processing target;
adding vertices included in each of the plurality of the shortest passing paths of the processing target to a vertex set included in the contracted graph structure data;
repeating a process of removing a shortest passing path having the vertices added to the vertex set as the passing points from the shortest passing path groups K2 times; and
the generating generates the contracted graph structure data based on the vertices included in the vertex set.

5. The non-transitory computer-readable storage medium according to claim 4, wherein:
the generating generates the contracted graph structure data based on an edge that couples the vertices included in the vertex set, and the vertices included in the vertex set in the graph structure data.

6. The non-transitory compute-readable storage medium according to claim 4, wherein:
when a shortest passing path within the plurality of shortest passing paths of the processing target includes a loop, only the passing point included in the shortest passing path of the processing target is added to the vertex set, and the number of repeated times of the process is not added by the adding.

7. A shortest path search device comprising:
a memory; and
a processor coupled to the memory and configured to perform a process of K1-shortest path search (K1 is a positive integer) from a first vertex to a second vertex in graph structure data that includes a plurality of vertices and a plurality of edges representing a coupling relationship between the vertices, the process including:
based on a shortest path from the first vertex to respective vertices included in the plurality of vertices and a shortest path from the second vertex to the respective vertices included in the plurality of vertices, deriving each of one or more shortest passing paths which are shortest paths of paths from the first vertex to the second vertex using any of the respective vertices as a passing point;
generating contracted graph structure data in which, among the shortest passing paths, vertices and edges that are not included in any of the shortest passing paths of K2 (K2 is a positive integer greater than or equal to K1) paths having a distance less than a threshold value are removed from the graph structure data, and
performing the process of K1-shortest path search with respect to the contracted graph structure data.

8. The shortest path search device according to claim 7, the process further comprising:
excluding derived shortest passing paths that are duplicates; and
specifying the shortest passing paths included in the K2 paths by sorting remaining shortest passing paths in ascending order of distance.

9. The shortest path search device according to claim 8, the process further comprising:
specifying vertices included in each of all the shortest passing paths from a first shortest passing path sorted in the ascending order of distance to the K2-th shortest passing path excluding a shortest passing path that includes a loop; and
the generating generates the contracted graph structure data based on an edge that couples the specified vertices, and the specified vertices in the graph structure data.

10. The shortest path search device according to claim 7, the process further comprising:
setting shortest passing path groups obtained by sorting the derived shortest passing paths in ascending order of distance, each of the shortest passing path groups includes a plurality of the shortest passing paths of a processing target;
adding vertices included in each of the plurality of the shortest passing paths of the processing target to a vertex set included in the contracted graph structure data;
repeating a process of removing a shortest passing path having the vertices added to the vertex set as the passing points from the shortest passing path groups K2 times; and
the generating generates the contracted graph structure data based on the vertices included in the vertex set.

11. The shortest path search device according to claim 10, wherein
the generating generates the contracted graph structure data based on an edge that couples the vertices included in the vertex set, and the vertices included in the vertex set in the graph structure data.

12. The shortest path search device according to claim 10, the process further comprising:
when a shortest passing path within the plurality of shortest passing paths of the processing target includes a loop, only the passing point included in the shortest passing path of the processing target is added to the vertex set, and the number of repeated times of the process is not added by the adding.

13. A shortest path search method, performed by a computer, to execute a process of K1-shortest path search (K1 is a positive integer) from a first vertex to a second vertex in graph structure data that includes a plurality of vertices and a plurality of edges representing a coupling relationship between the vertices, the method comprising:
based on a shortest path from the first vertex to respective vertices included in the plurality of vertices and a shortest path from the second vertex to the respective vertices included in the plurality of vertices, deriving each of one or more shortest passing paths which are shortest paths of paths from the first vertex to the second vertex using any of the respective vertices as a passing point;
generating contracted graph structure data in which, among the shortest passing paths, vertices and edges that are not included in any of the shortest passing paths of K2 (K2 is a positive integer greater than or equal to K1) paths having a distance less than a threshold value are removed from the graph structure data; and
performing the process of K1-shortest path search with respect to the contracted graph structure data.

14. The shortest path search method according to claim 13, the method further comprising:
excluding derived shortest passing paths that are duplicates and specifying the shortest passing paths included in the K2 paths by sorting remaining shortest passing paths in ascending order of distance.

15. The shortest path search method according to claim 14, the method further comprising;
specifying vertices included in each of all the shortest passing paths from a first shortest passing path sorted in the ascending order of distance to the K2-th shortest passing path excluding a shortest passing path that includes a loop; and
the generating generates the contracted graph structure data based on an edge that couples the specified vertices, and the specified vertices in the graph structure data.

16. The shortest path search method according to claim 14, the method further comprising:
setting shortest passing path groups obtained by sorting the derived shortest passing paths in ascending order of distance, each of the shortest passing path groups includes a plurality of shortest passing paths of a processing target;
adding vertices included in each of the plurality of the shortest passing paths of the processing target to a vertex set included in the contracted graph structure data;
repeating a process of removing a shortest passing path having the vertices added to the vertex set as the passing points from the shortest passing path groups K2 times; and
the generating generates the contracted graph structure data based on the vertices included in the vertex set.

17. The shortest path search method according to claim 16, wherein:
the generating the contracted graph structure data based on an edge that couples the vertices included in the vertex set, and the vertices included in the vertex set in the graph structure data.

18. The shortest path search method according to claim 16, the method further comprising:
when a shortest passing path within the plurality of shortest passing paths of the processing target includes a loop, only the passing point included in the shortest passing path of the processing target is added to the vertex set, and the number of repeated times of the process is not added by the adding.
